(19) United States
(12) Patent Application Publication
(10) Pub. No.: US 2014/0222547 A1
(43) Pub. Date: Aug. 7, 2014

(54) PRODUCT CUSTOMIZATION RECOMMENDATIONS BASED ON USER INFORMATION FROM A SOCIAL NETWORKING SYSTEM

(71) Applicant: Facebook, Inc., Menlo Park, CA (US)

(72) Inventors: Keenan Pridmore, Chicago, IL (US); Philip John MacGregor, IV, Chicago, IL (US); Stephen Biddle, Oak Park, IL (US)

(73) Assignee: Facebook, Inc., Menlo Park, CA (US)

(21) Appl. No.: 13/759,973

(22) Filed: Feb. 5, 2013

(51) Int. Cl. H04L 29/08

(52) U.S. Cl. CPC H04L 67/22
USPC 705/14.39; 709/204

(57) ABSTRACT

A social networking system requests a customizable product from a retailer. The retailer accesses social information associated with one or more additional users connected to the social networking system users and generates recommendations for options to customize the customizable product based on the social information associated with the additional users. When the social networking system orders a customizable product using one of the recommended options, the social networking system is notified and generates a story describing the purchase that is communicated to the additional users of the social networking system.

### BACKGROUND

The present disclosure relates generally to social networking systems, and more particularly to recommending customizations for products based on information from a user's social network.

Social networking systems, or social utilities that track and enable connections between users (including people, businesses, and other entities), have become prevalent in recent years. In particular, a social networking system allows users to more efficiently communicate information that is relevant to their friends or other connections in the social network. Social networks typically incorporate a system for maintaining connections among users in the social network and links to content that are likely to be relevant to the users. Social networks also collect and maintain information about the users of the social network. This information may be static, such as geographic location, employer, job type, age, music preferences, interests, and a variety of other attributes, or it may be dynamic, such as tracking a user's actions within the social network.

Additionally, many retailers allow consumers to customize products with various options. For example, a pizza restaurant allows a consumer to customize the toppings that the consumer wants to be included is his or her pizza. Users of social networking systems frequently customize products from these retails, and the options they use for customization may be of interest to other social networking system users. However, conventional retailers are unable to provide recommendations to users of options to configure customizable products based on social information of the user's friends in a social networking system.

### SUMMARY

A social networking system user orders a customizable product, which is associated with multiple options that the user may select. For example, the user orders the customizable product from a retailer. Information associated with the user by the social networking system is accessed and used to generate recommendations of options for the customizable item and/or other customizable items. In one embodiment, the recommendations of options are each associated with an additional user connected to the user ordering the customizable product, and may be generated based on information associated with the additional user by the social networking system. For example, the social networking system may identify pizza toppings to recommend to the user for a pizza based on social information of the user's friends in the social networking system.

In one embodiment, recommendations of options for the customizable products are associated with social information associated with users of the social networking system connected to the user ordering a customizable product (the “ordering user”). For example, the social networking system identifies actions performed by one or more social networking system users connected to the ordering user and selects options for customizing the products based on the actions. The social networking system or retailer may store information mapping actions to product options to determine options to recommend, allowing options for a customizable product to be recommended based on actions performed by a user connected to the ordering user.

The social networking system or retailer may associate options used to configure a customizable product with a user connected to the ordering use that ordered the customizable product having the associated options or with a user associated with social information used to select recommended options for a customizable product. If the ordering user orders a customizable product having options associated with a user connected to the ordering user, the social networking system may send a notification to user associated with the options for the ordered customizable product. The notification may be sent to the user associated with the options of the ordered customizable product via any suitable channel. Examples of notification channels include: a story in a news feed, a message, an e-mail, a text message, or any other suitable notification method. The notification identifies the ordering user and the options selected by the ordering user for the customizable product. In one embodiment, the user associated with the options for the ordered customizable product may accumulate rewards such as points or other representations of value such as money or coupons that may be redeemed at the retailer for a free or discounted product when other social networking system users order the customizable product using the options associated with the user.

In one embodiment, a notification is also transmitted to other users connected to the ordering user when the ordering user orders a customizable product. As described above, the notification may be transmitted using any suitable channel. The notification identifies the options selected by the ordering user for the customizable product. The notification may also provide information describing the options selected by the ordering user.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a high-level block diagram of system environment for recommending customizable products, in accordance with one embodiment.

FIG. 2 illustrates a user interface for presenting recommendations of options for customizable products based on social information, in accordance with one embodiment.

FIG. 3 illustrates an interaction diagram describing a process for ordering a customizable product, in accordance with one embodiment.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

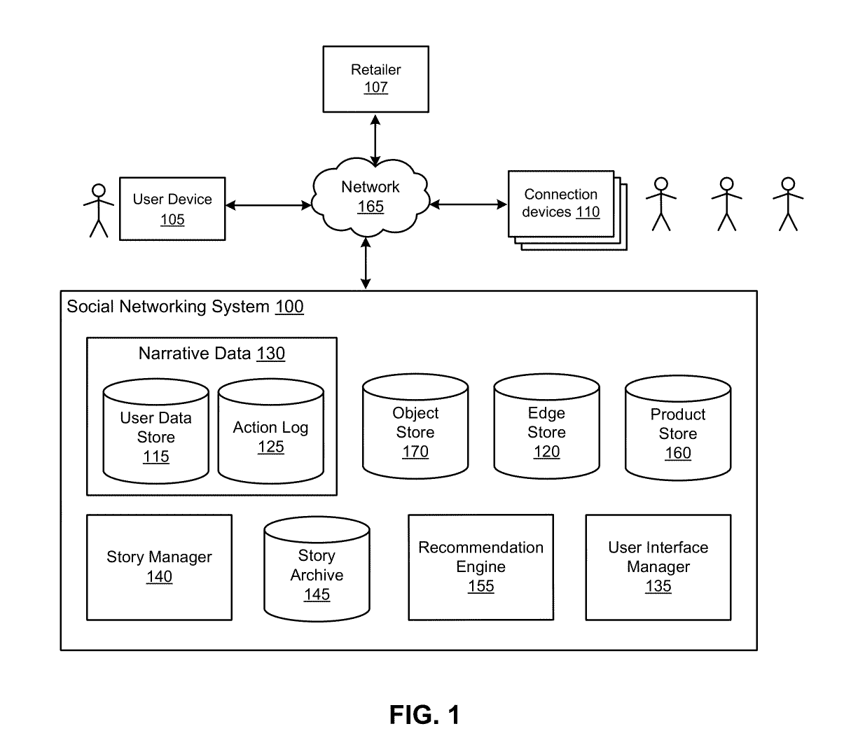

FIG. 1 illustrates a system environment for recommending customizable products to users of a social networking system 100. A customizable product has one or more options that may be selected by a user ordering the customizable product (an “ordering user”). Examples of customizable products include pizzas, sandwiches, electronics, clothing, or any other product having various options for its appearance or construction. However, any customizable product that includes various options for customizing the product that are determined based on social information of users may be considered a customizable product such as consumer electronics. As further described below, options for a customizable product are recommended to the ordering user based on information maintained by a social networking system 100 for other users connected to the ordering user.

Generally, the social networking system 100 offers its users the ability to communicate and interact with other social networking system users. As used herein, a “user” may be an individual or entity (such as a business or a third party application). Also, as used herein, a “connection” identifies a user of the social networking system 100 to which another user may form, or has formed, an association or other relationship. Users join the social networking system 100 and then connect with other users, individuals, and entities to which they desire to be connected. A user may explicitly add a connection. For example, a user selects another user to be a friend of the user. Alternatively, a connection between the user and another user may be automatically created by the social networking system 100 based on common characteristics of the users (e.g., users who are alumni of the same educational institution). Connections in social networking systems may be in both directions or may be in just one direction. For example, if Bob and Joe are both users and connect with each another, Bob and Joe are each connections of the other. If, on the other hand, if Bob wishes to connect to Sam to view Sam's posted content items, but Sam does not choose to connect to Bob, a one-way connection may be formed where Sam is Bob's connection, but Bob is not Sam's connection. Some embodiments of a social networking system 100 allow the connection to be indirect via one or more levels of connections (e.g., friends of friends).

In addition to interactions with other users, the social networking system 100 provides users with the ability to take actions on various types of objects supported by the social networking system 100. These objects may include groups or networks of users to which users of the social networking system may belong, events or calendar entries in which a user might be interested, computer-based applications that a user may use via the social networking system 100, transactions that allow users to buy or sell items via the social networking system 100, and interactions with advertisements that a user may perform on or off the social networking system 100. These are just a few examples of the objects upon which a user may act on a social networking system 100, and many others are possible. Though many of the embodiments and examples provided herein are directed to particular embodiments of a social networking system 100, other embodiments may include other environments involving different types of social networks, social content, and other types of websites and communication mechanisms.

User generated content enhances the user experience on the social networking system. Users may provide various content items to the social networking system 100, which stored the content items and associates them with one or more users. Content items are pieces of content that are represented as objects in the social networking system 100. Examples of content items include any type of media content, such as status updates or other textual messages, location information, photographs, images, videos, advertisements, links, or other content. Content items are pieces of content that are represented as objects in the social networking system 100. By maintaining content items, the social networking system 100 encourages its users to communicate with each other by “posting” content items of various types of media through various communication channels to the social networking system 100. This increases the frequency with which users of the social networking system 100 engage with each other and with the social networking system 100.

One type of communication channel is a “stream” in which a user is presented with a series of content items that are posted, uploaded, or otherwise provided to the social networking system from one or more users of the service. The stream may be updated as users add content items to the stream. Example communication channels for a social networking system are discussed further in U.S. application Ser. No. 12/253,149, filed Oct. 16, 2008, which is hereby incorporated by reference in its entirety.

Users interact with the social networking system 100 using client devices, which are shown in FIG. 1 as a user device 105 and connection devices 110. The user device 105 and/or connection devices 110 are for interacting with the social networking system 100 and the retailer 107 and may be any computing device having data processing and data communication capabilities. Examples of client devices include a personal computer (PC), a desktop computer, a laptop computer, a notebook, a personal digital assistant (PDA), mobile telephone, smart phone, or a tablet computer. These devices may include a camera or other image capture device allowing image and video content to be captured and uploaded to the social networking system 100. A client device also includes an input device for receiving input from a user. Examples of input devices include: a touch screen, a gesture recognition system, a touch pad, a keyboard, a dial pad, or other technology that allows a user to provide input. For example, a user provides input to the social networking system 100 via an input device and a user interface provided by the social networking system 100.

Interactions between the user device 105, connection devices 110 and the social networking system 100 are typically performed via a network 165, for example, via the internet. The network 165 enables communications between the user device 105, connection devices 110, the retailer 107, and the social networking system 100. The network 165 includes wireless networks, wired networks, or any suitable combination of wired and wireless networks. In one embodiment, the network 165 uses standard communications technologies and/or protocols. Thus, the network 165 may include links using technologies such as Ethernet, 802.11, worldwide interoperability for microwave access (WiMAX), 3G, 4G, LTE, digital subscriber line (DSL), asynchronous transfer mode (ATM), InfiniBand, PCI Express Advanced Switching, etc.

In one embodiment, the client device 105 executes a user interface or application to allow a user to interact with the social networking system 100. The user interface or application allows the user to perform various actions or activities associated with the social networking system 100 and to view information provided by the social networking system 100. Example actions performed using the user interface include: adding connections, posting messages, posting links, uploading images or videos, updating the user's profile settings, viewing stories, and the like. Examples of information provided by the social networking system 100 that can be viewed using the user interface include: images or videos posted by the user's connections, comments posted by the user's connections, messages sent to the user by other users, wall posts, etc.

For purposes of illustration, when a user “A” views the data of another user “B,” user “A” is called the “viewing user,” and the user “B” is called the “subject user.” The user interface allows a viewing user to view the data of other subject users of the social networking system 100 as well as general data related to news, sports, interests, etc. Information in the user interface may be presented to viewing users in different views. For example, the social data of subject users can be presented to viewing users by way of a “profile page,” which is an arrangement of the subject users' social networking data. The information about subject users may also be presented in the form of a news feed including stories describing actions performed by various subject users. In one embodiment the different views are represented using data and code in a web standard format presented through a browser. For example, a news feed may comprise a combination of any of extensible markup language (XML), hypertext markup language (HTML), cascading style sheets (CSS), JAVASCRIPT®, plaintext, and/or JAVA® sent from a server of the social networking system 100 to a web browser running on a client device, such as a user device 105. In another embodiment a news feed may comprise data formatted for presentation through a mobile app or desktop application.

In one embodiment, the user device 105 includes a web browser application (not shown) allowing the user device 105 to exchange information with the social networking system 100 and/or the retailer 107 via the network 165. Alternatively, the user device 105 includes one or more applications associated with the social networking system 100 and/or with the retailer 107, so an application is used to exchange data between the user device 105 and the social networking system 100 or the retailer 107.

In one embodiment, a retailer 107 sells customizable products to users of the social networking system 100. A customizable product may include various options that may be selected by a user to configure the product. For example, the retailer 107 may sell pizzas, and allows users to customize the toppings included on their pizzas according to their own individual preferences or requirements. Alternatively, the retailer 107 may be an electronics retailer that allows users to customize electronics with various options.

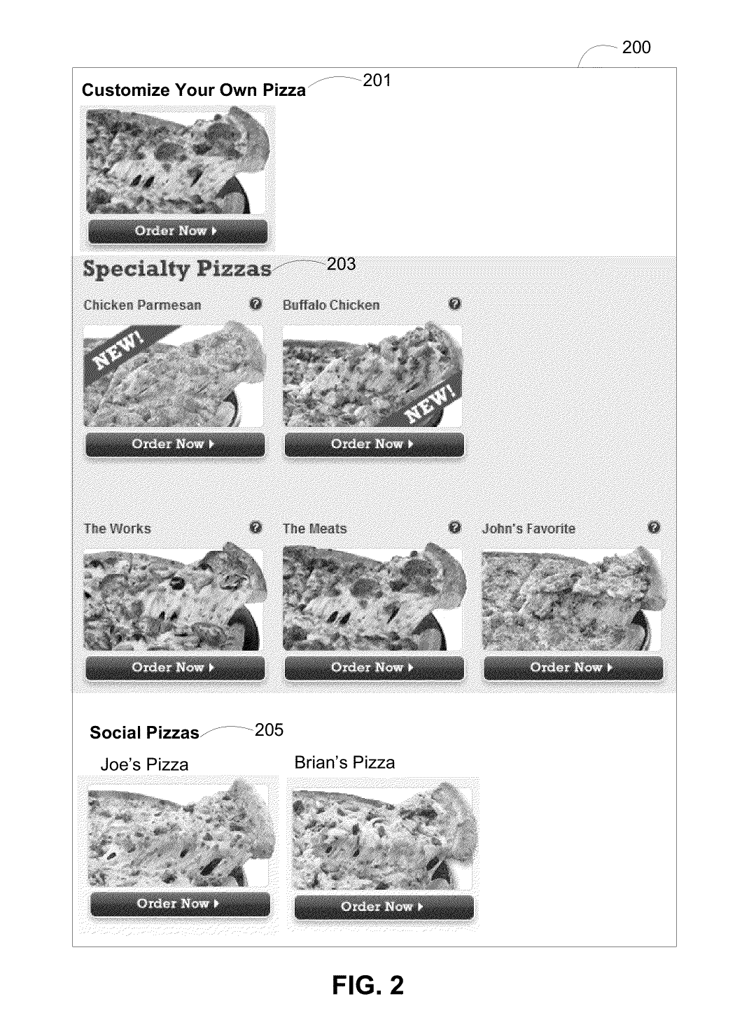

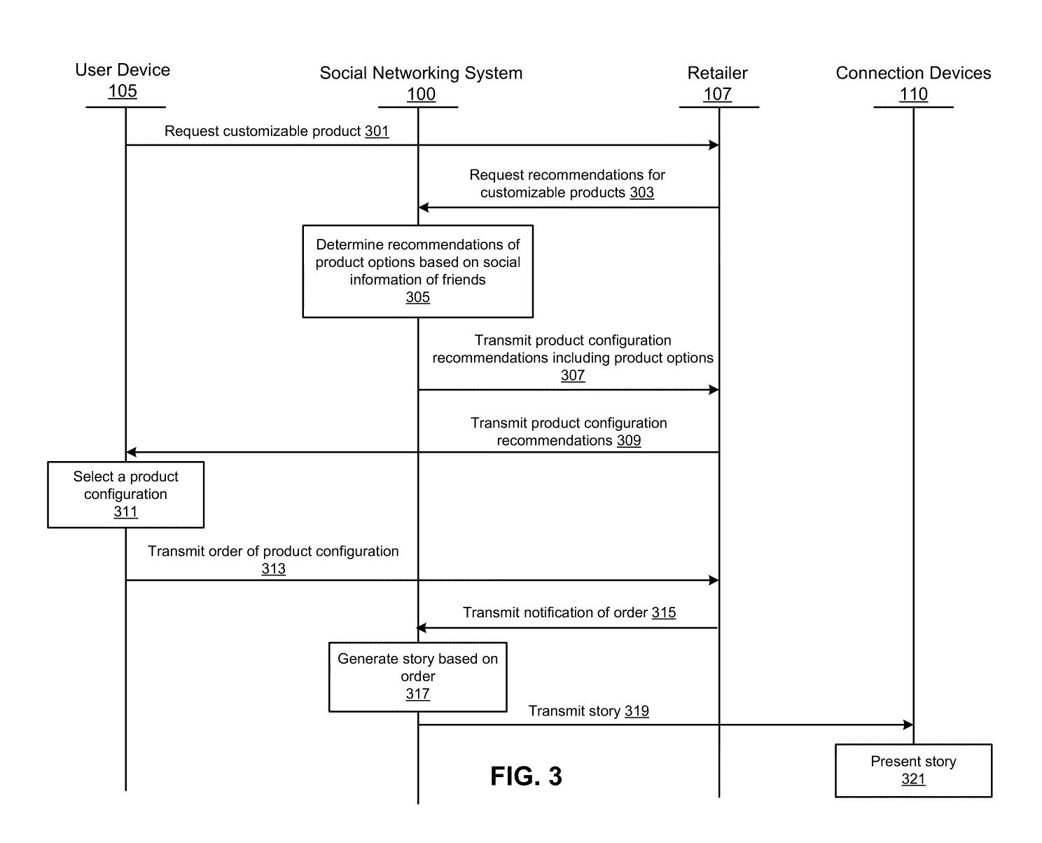

In one embodiment, the retailer 107 provides recommendations to a user of options to customize customizable products based on social information from the social networking system 100 that is associated with other users connected to the user. Social information describes any activities and/or actions stored by the social networking system 100 and associated with a user on the social networking system that may used as the basis from which the social networking system 100 identifies recommendations of customizable products to the user as further described below in conjunction with FIGS. 2 and 3. Examples of social information used to recommend options for a customizable product include posts of content to the social networking system 100, indications of interest (e.g., “likes”) of content in the social networking system 100, check-ins at a location, or any other suitable action. Additionally, social information may also include information included in a user profile such as the user's place of birth, ethnicity, residence information, etc. In one embodiment, the retailer 107 receives the recommendations of options for a customizable product from the social networking system 100 and displays the recommendations to the user on user device 105. Alternatively, the retailer 107 determines the recommendations of options based on information received from the social networking system 100.

In one embodiment, the retailer 107 provides a website from which users may order customizable products offered by the retailer 107, as shown in FIG. 2. In the example of FIG. 2, the customizable products are pizzas, although in other embodiments any suitable customizable product may be shown. The retailer 107 allows users to select different options for a customizable product from the website according to the user's specifications. For example, if the retailer 107 is a pizza restaurant, the retailer 107 provides a “customize” option 201 that allows the user to select the particular toppings to include on a pizza sold by the retailer 107. The retailer 107 also provides preconfigured products 203 having options preselected by the retailer 107. For example, the retailer 107 allows selection of preconfigured products 203 that are “specialty pizzas” including toppings pre-selected by the retailer 107.

In one embodiment, the retailer 107 includes socially customized products 205 on its website. A socially customized product 205 is a customizable product having options selected based on social information associated with users of the social networking system 100 connected to the user viewing the retailer website. In FIG. 2, the socially customized products 205 are identified as “social pizzas.” The social pizzas shown in FIG. 2 include “Brian's Pizza” or “Joe's Pizza” where Brian and Joe are social networking system users connected to the user viewing the website. The options of a socially customized product 205 may be determined from options selected by a social networking system user when ordering a customizable product or may be selected based on social information associated with a social networking system user connected to the user viewing the website. In FIG. 2, the social pizzas shown include one or more toppings that are based on social information of Brian and Joe maintained by the social networking system 100. Hence, the retailer 107 displays recommendations of options for configuring a customizable product based on information from the social networking system 100 to further customize a user's interaction with the retailer 107.

In one embodiment, the retailer 107 provides a login page to a user via the user device 105 to receive login credentials for accessing the social networking system 100 from the user. Without access to the social networking system 100, the retailer 107 is unable to receive social information associated with social networking system users 100 to recommend options for customizable products. Login credentials received via the login page are communicated to the social networking system 100 to access a user profile of the user maintained by the social networking system 100 and to allow the retailer 107 to access social information associated with additional users connected to the user. In one embodiment, the login credentials include a user name and password, but may be any suitable login information that is verified by the social networking system 100. In one embodiment, the login credentials are provided to the retailer 107, which communicates the login credentials to the social networking system 100. Alternatively, the login credentials are communicated to the social networking system 100 to verify the user. After the social networking system 100 verifies the user's login credentials, the website of the retailer 107 presents the user with recommendations of options for customizable products based on social information associated with other social networking system users.

Referring back to FIG. 1, a social network story posted in the social networking system 100 (or “story”) is an aggregation of data gathered by the social networking system 100 that is configured for display in various social networking system views (user interface views). For example, stories may be presented to viewing users in a continuously updated real-time newsfeed in a web browser, in a timeline view, or on a user's profile page. A story aggregation is a collection of one or more stories gathered together for display. For example, all the stories related to a particular event, such as a birthday party, may be aggregated into one story aggregation.

When a user joins the social networking system 100 the user creates a user account, which enables the user to maintain a persistent and secure identity on the social networking system 100. The user account may include a user profile that stores details or characteristics about the user. Examples of details or characteristics stored in the user profile include name, age, sex, interests, location, education history, employment information, relationship status etc. The social networking system 100 may provide a user with stream of data to keep the user updated on the activities of the user's connections, as well as to inform the user about news and information related to the user's interests. This stream of data may include stories, which are collections of related data presented together to the user, and story aggregations, which are collections of stories presented to the user.

The social networking system 100 maintains different types of data objects, for example, user data objects, action objects, and edges. A user data store 115 includes user data objects. In one embodiment, a user data object comprises user profile information related to a social networking system user. For example, a user data object stores characteristics of the user such as a user's date of birth, interests, education information, employment information, a photograph of the user, a reference to a photograph of the user or other suitable information about the user.

In one embodiment, an object store 170 stores objects of the social networking system 100. Objects include digital photographs, videos, documents, or any other items uploaded by users of the social networking system 100 and their associated tags. Tags associated with a photograph may describe the user(s) that are included in the photograph, events associated with the photograph, geographical locations associated with the photograph, a date associated with the photograph or any other descriptive information. The photographs may be arranged into various photograph albums established by the user that uploaded the photographs to the social networking system 100. The object store 170 may also store other objects such as video, audio, word documents, etc.

An edge store 120 stores edges describing relationships and/or associations between users other users, users and objects stored in the object store 170 and/or objects and objects on the social networking system 100. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system 100 (“liking” a page), sharing a link with other users of the social networking system, and commenting on posts made by other users of the social networking system. The edge store 120 stores information about the edges, such as affinity scores for objects, interests, and other users as will be further described below.

A product store 160 stores options for customizable products offered by a retailer 107. In one embodiment, the product store 160 associates options for configuring or customizing a customizable product with social information. In one embodiment, the product store 160 stores a table mapping options with social data. In the social pizza example, a table may map pizza topping options with social data describing geographic locations that are associated with pizza toppings. For illustration, Table 1 shows an example of a table for mapping social information to pizza options.

TABLE 1
Example option table

| Social Information | Pizza Options |
|---|---|
| New York | Thin crust |
| Chicago | Deep dish crust |
| Hawaii | Pineapple and ham |
| California | Avocado |
| Texas | Beef brisket |

As further described below, the product store 160 is accessed to identify options for a customizable product based on social information of users connected to a user ordering a customizable product (an “ordering user”). Options associated with social information are identified and presented to the ordering user along with an identification of the user associated with the social information. This allows a retailer 107 to personalize options recommended to an ordering user based on the ordering user's connection to other users in the social networking system 100.

While the preceding example describes the selection of options for a pizza based on social information, the product store 160 may include information associating options for any suitable customizable product with social information. In one embodiment, the product store includes multiple tables associating social information with options, with each table associated with a different retailer 107. For example, a table may associate social information with options for consumer electronics; as an example, social information indicating an interest in video games or movies may be associated with larger television screen sizes (e.g., 65 in and greater) for consumer electronics. In another example, interest in computer games may be associated with faster clock speed options for computer graphic cards. In yet another example, an interest in music may be associated with higher memory capacity options for digital music players to allow users to store more music. As an additional example, an interest in digital photography of specific types of content such as moving objects, landscape, etc. may be associated with various types of camera lenses that are configured to capture the type of content of interest. Hence, the product store 160 may associate any suitable social information with options for customizing products provided by various retailers 107.

The action log 125 stores actions performed by users of the social networking system 100 with respect to content items, or objects, stored in the object store 170 or with respect to other users. In one embodiment, an action describes an interaction performed by users with respect to content items which have been logged in order to enhance the users' experience in the social networking system 100. Almost any activity of a user that is directed towards a content item may be stored as an action in the action log 125. For example, an interaction may be the posting of a new comment or status update, dismissing content items such as an advertisement or post, or establishing a connection to another user. In one embodiment, each action is assigned a unique action identifier (ID) and is stored with a user identifier (ID) associated with the user that performed the action with respect to content item corresponding to the action. The user data included in the user data store 115 and the actions included in the action log 125 are collectively referred to as narrative data 130.

The social networking system 100 maintains a social graph that tracks the relationship between the various objects, users, and events captured by the social networking system 100. In the social graph the users, the user data and other entities exist as nodes that are connected to each other via edges. In this embodiment, the edges represent actions that create a relationship between the nodes. For example, a node representing a photograph stored in the social networking system 100 may have an edge to a user that uploaded the photograph, and this edge may be an “uploaded by” action. The same photograph may have edges to several other nodes that represent the users in that photograph, and these edges may be “tagged in” actions. Similarly, a node representing a user in the social networking system 100 may have edges to each node representing posts made by that user. These edges may all be “posted by” actions. The edges in the social graph can have different types that correspond to the different types of actions taken by users of the social networking system 100.

The social networking system 100 may maintain or compute a measure of a user's “affinity” for other users (or objects) in the social networking system 100. The measure of affinity may be expressed as an affinity score, which may represent that user's closeness to another user (or object) of the social networking system 100. The affinity score of a user X for another user Y can be used to predict, for example, if user X would be interested in viewing, or would be likely to view, a photo of user Y. The affinity scores can be computed by the social networking system 100 through automated methods, including through predictor functions, machine-learned algorithms, or any other suitable algorithm for determining user affinities. An archive of historical affinity scores for a user may be stored by the social networking system 100 as the user's affinity scores for various users and objects changes over time. Computing user affinities for other users or objects of a social networking system 100 is further disclosed in U.S. application Ser. No. 12/978,265, filed on Dec. 23, 2010, which is hereby incorporated by reference in its entirety.

The social networking system 100 also includes a user interface manager 135. The user interface manager 135 provides server-side functionality allowing social networking system users 100 to interact with the social networking system 100 via a user interface. When users request information from the social networking system 100, the user interface manager 135 dispatches the requested information to users in a format that can be displayed through a client device, such as a user device 105 or a connection device 110. For example, when a user requests a news feed from the social networking system 100, the user interface manager 135 sends stories and story aggregations to a user device 105 and/or connection devices 110 that are configured to be displayed on the devices. Depending on the type of information requested by a user, the user interface manager 135 may send stories, story aggregations, profile pages, timelines, or other data to a client device.

The story manager 140 manages the story generation process. The story manager 140 comprises story generators configured to generate stories for different purposes (i.e., different views), which are stored in the story archive 145. Story generators are configured to generate stories for a particular target view, and may restrict the selection of narrative data used in story generation based on the target view. For example, a story generator may be configured to generate stories for a photo album view, and restrict the narrative data used for story generation to narrative data including or referencing images. Stories generated to be displayed in a user interface of a mobile device may include different data than stories generated to be displayed in a desktop computer interface, and they may be differently visually formatted to optimize for differences between a desktop computer display and a mobile device display (e.g., larger icons for a smaller smartphone screen). The social networking system 100 may also restrict the stories that are provided to a viewing user to stories including data related to the connections of the viewing user (i.e., to stories including data about subject users that are connected to the viewing user in the social networking system 100)

In one embodiment, the story manager 140 generates a newsfeed, which comprises a scrollable list of the most relevant recent stories that may be of interest to a viewing user. In one embodiment, the story manager 140 includes a notification in a news feed when the user orders a customizable product from a retailer 107. Hence, when a user purchases a customizable product from the retailer 107, the story manager 140 notifies other users connected to the ordering user of the purchase and may also identify the options selected by the ordering user to customize the customizable product. For example, if the user orders “Brian's Pizza,” which includes options recommended by the social networking system 100, the story manager 140 generates a notification of the order that is sent to the user's friends in the social networking system 100. In one embodiment, the notification may also include a description of how the options were recommended. For example, “Brian's Pizza” may include a deep dish crust, pineapple and ham. The notification may explain that the options selected for “Brian's Pizza” were recommended because Brian recently visited Hawaii and currently lives in Chicago. Thus, the story manager 140 may describe the rationale for recommending options for a customizable product based on social information associated with social networking system users. In one embodiment, the notification also includes an option allowing users to order the customizable product with the options identified by the notification from the notification.

In one embodiment, the story manager 140 may create a notification specifically for a user connected to the ordering user associated with recommended options for an ordered customizable product. The notification alerts the user associated with social information used to recommend the options. For example, if “Brian's Pizza” is ordered by the user, the story manager 150 generates a notification specifically for Brian identifying that the ordering user ordered a pizza having toppings based on Brian's social information. In one embodiment, the notification includes rewards such as points, or other credits including money or coupons, that may be redeemed by the user associated with the social information used to recommend the options of the ordered customizable product at the retailer 107 for products (e.g., a pizza). In one embodiment, each order is associated with a single point. If a threshold number of points (e.g., 8 points) are accrued, the user associated with the social information used to recommend the options may redeem the points for a free or discounted product from the retailer 107.

In one embodiment, the story manager 140 determines a viewing user's interest for stories when identifying stories for inclusion in a news feed for the viewing user. For example, the story manager 140 may determine the viewing user's affinity for stories and use the affinities to select stories for the newsfeed, although any other suitable method for determining interest in stories may be used. The story manager 140 may also generate a timeline, which is a chronological list of stories related to a particular subject user that are ordered by time period. In some embodiments, a timeline may alter the ranking of some stories depending on other factors such as social importance or likely engagement value. Stories that are configured for display in a timeline are called timeline units. A timeline may also include special “report” units, which include multiple timeline units that have been aggregated together. For example, a user may have several wall posts from friends during the month of November. That user's timeline may then include a report unit containing all posts from friends during that month or when the user ordered a customizable product from the retailer 107 or when the user's friends ordered a customizable product associated with the user from the retailer 107. For newsfeeds and timelines there may be multiple story generators producing stories of different types that are displayed together. Generating stories for a newsfeed from data captured by a social networking system 100 are disclosed in U.S. application Ser. No. 11/503,037, filed on Aug. 11, 2006, and U.S. application Ser. No. 11/502,757, filed on Aug. 11, 2006, which are hereby incorporated by reference in their entirety. Timelines and timeline units are discussed in more detail in utility application U.S. application Ser. No. 13/239,347, filed on Sep. 21, 2011, which is also hereby incorporated by reference in its entirety.

In one embodiment, the social networking system 100 comprises a recommendation engine 155. The recommendation engine 155 provides recommendations of options for customizable products to the retailer 107 based on social information stored by the social networking system 100 which are then provided to users by the retailer 107. In one embodiment, the recommendation engine 155 provides recommendations for customizable products when a user has provided his or her login credentials to the social networking system 100 through the retailer 107, or has otherwise been authenticated by the social networking system 100. This prevents the retailer 107 from being granted unauthorized access to the user's social information.

Recommendations of options for customizable products are based on social information associated with other users of the social networking system 100 connected to the user ordering a customizable product (the “ordering user”). In one embodiment, to identify configuration options for customizable products to provide to the retailer 107, the recommendation engine 155 accesses user profiles associated with additional users connected to the ordering user and retrieves social information associated with the additional users. For example, information describing actions by the additional users, interests of the additional users, demographic information of the additional users, or other suitable information is retrieved. The recommendation engine 155 compares the retrieved social information to information in the product store 160 to identify one or more options corresponding to the retrieved social information. The recommendation engine 155 generates recommendations identifying the customizable product and one or more options corresponding to retrieved social information; the generated recommendation may also identify the additional user associated with the social information used to identify the one or more options.

For example, the recommendation engine 155 may determine that the ordering user is connected to an additional user, and the additional user's user profile indicates that the additional user recently visited Hawaii based on posts by the additional user describing locations in Hawaii. The posts may include textual posts indicative of various locations the additional user visited in Hawaii. Accordingly, the recommendation engine 155 compares “Hawaii” with one or more tables in the product store 160 to determine if “Hawaii” is associated with one or more options by the retailer 107 providing the customizable product to the ordering user. If the product store 160 associates “Hawaii” with an option, the recommendation engine generates a recommendation for the customizable product including the option associated with “Hawaii.” For example, if the customizable product is a pizza, and the product store 160 includes a table associated with the retailer 107 mapping “Hawaii” to “pineapple and ham,” the recommendation engine 155 generates a recommendation for a pizza having pineapple and ham as toppings. Additional options may be identified if additional social information associated with the additional user matches additional options from the product store 160. The recommendation engine 155 may associate the recommendation with the additional user associated with the social information used to identify the options for the customizable product.

In another example, the recommendation engine 155 may identify that an ordering user is connected to an additional user, “Stan,” which regularly posts content in the social networking system 100 describing digital photographs of zoomed in objects. The recommendation engine 155 may use the social information “zoom” and “digital photographs” as keywords and search the product store 160 for options for customizable products sold by a retailer 107 visited by the ordering user that correspond to “zoom” and “digital photographs.” If the retailer 107 is an electronics store, the social information “zoom” and “digital photographs” may be associated with options identifying various zoom lenses or camera models old by the retailer 107.

In one embodiment, the functionality described above in conjunction with the recommendation engine 155 is provided by the retailer 107. The social networking system 100 may communicate social information to the retailer 107, which identifies recommendations of options for a customizable product based on the received social information. In another embodiment, the social networking system 100 may function as the retailer 107 and thus may offer customizable products to users of the social networking system 100.

### Providing Recommendations of Customizable Product Options to a User

FIG. 3 illustrates an interaction diagram describing one embodiment of a process 300 for recommending options for customizable products to a user. In other embodiments, different and/or additional steps than those shown in FIG. 3 may be performed.

In one embodiment, the user device 105 requests 301 a customizable product from a retailer 107 via a network 165. For example, a user of the user device 105 requests 310 a page from the retailer 107 including one or more customizable products offered by the retailer 107, such as pizzas. In one embodiment, the request also includes login credentials for a social networking system 100 to access a user profile and other social information stored by the social networking system 100. The retailer 107 requests 303 recommendations of options for customizable products from the social networking system 100. The request from the retailer 107 identifies the retailer 107, the user of the user device 105 and may also identify one or more customizable products offered by the retailer 107. The social networking system 100 determines 305 recommendations of options for a customizable product based on social information of the additional users connected to the user of the user device 105 in the social networking system 100.

As mentioned previously, the social networking system 100 analyzes social information connected to the user of the user device 105 and determines 305 recommendations of options for a customizable product from the retailer 107 based on the social information. For example, the social networking system 100 determines 305 whether social information associated with a user is mapped to an option for a customizable product based on information in a product store 160, as described above in conjunction with FIG. 1. Recommendations of options for the customizable product determined from the social information are transmitted 307 to the retailer 107 via the network. In one embodiment, the transmitted 307 option recommendations are based in part on affinities of the user of the user device 105 for the users associated with the social information used to generate the option recommendations. For example, options based on social information associated with users with which the user of the user device 105 has at least a threshold affinity or with which the user of the user device 105 has the highest affinities are transmitted 307. Other criteria may be used to identify option recommendations for transmission. For example, options based on social information associated with users purchasing a customizable product from the retailer 107 within a threshold time from a current time, associated with users having a threshold affinity for the retailer 107, associated with users having a threshold number of interactions with the retailer 107, or associated with users having any suitable criteria may be transmitted 307. For example, the social networking system 100 transmits toppings for one or more pizzas based on the social information of users connected to the user of the user device 105 in the social networking system 100.

The retailer 107 then transmits 309 the product configuration recommendations for customizable products to the user device 105. The user selects 311 options for the customizable product via the user device 105, and may select 311 options recommended by the social networking system based on social information. For example, the user may select to order “Brian's Pizza,” which specifies a pizza including toppings based on social information associated with the user Brian. The user device 105 transmits 313 an order for the customizable product specifying the selected options to the retailer 107, which transmits 315 a notification of the order to the social networking system 100. The notification may identify the social networking system user associated with the social information used to determine the selected options. For example, the retailer 107 notifies the social networking system 100 that the user ordered “Brian's Pizza.”

The social networking system 100 generates 317 a story, or other notification, based on the order that indicates that the user ordered the customizable product and transmits 319 the story to additional social networking system users connected to the user of the user device 105. The story is presented 321 to the additional social networking system users via their connection devices 110. For example, the story may be presented 321 as a story in newsfeeds of additional users connected to the user of the user device 105. However, in other embodiments, the story may be presented 321 using any suitable communication channel, such as e-mail, text message, notification, or any other suitable channel.

In one embodiment, the social networking system 100 identifies a user associated with the social information used to determine the selected options to the retailer 107. The retailer may then provide a credit to an account associated with the identified user. For example, the retailer credits a rewards program associated with the identified user when the options based on social information of the identified user are selected.

### SUMMARY

The foregoing description of the embodiments herein has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

The embodiments described herein may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments herein is intended to be illustrative, but not limiting, of the scope of the invention, which is set forth in the following claims.

What is claimed is:

1. A computer-implemented method comprising:
storing a user profile for a user of a social networking system, the user connected to one or more additional users of the social networking system;
receiving a request for a recommendation of options for a customizable product, the customizable product having a plurality of selectable options;
retrieving social information comprising information about the one or more additional users of the social networking system connected to the user;
determining one or more recommended options for the customizable product based on the retrieved social information associated with the one or more additional users of the social networking system connected to the user; and
providing the one or more recommended options to the user.

2. The computer-implemented method of claim 1, wherein determining one or more recommended options for the customizable product based on the retrieved social information associated with the one or more additional users of the social networking system connected to the user comprises:
retrieving social information associated with an additional user of the social networking system connected to the user;
determining one or more options for the customizable product based on the retrieved social information associated with the additional user; and
associating the determined one or more options for the customizable product with the additional user.

3. The method of claim 2, wherein providing the one or more recommendations to the user comprises:
providing the user with the one or more options for the customizable product based on the retrieved social information associated with the additional user and identifying the additional user to the user.

4. The computer-implemented method of claim 1, further comprising:
receiving a notification that the user ordered the customizable product having a recommended option; and
transmitting a notification to the additional users of the social networking system indicating the user ordered the customizable product and identifying the recommended option of the ordered customizable product.

5. The computer-implemented method of claim 1, wherein the customizable product comprises a pizza and the plurality of selectable options comprise toppings for the pizza.

6. The computer-implemented method of claim 1, wherein providing the one or more recommended options to the user comprises:
determining affinities between the user and each of the additional users connected to the user;
selecting recommended options based on social information associated with one or more additional users having at least a threshold affinity; and
providing the selected recommended options to the user.

7. The computer-implemented method of claim 1, wherein providing the one or more recommended options to the user comprises:
determining affinities between the user and each of the additional users connected to the user;
selecting recommended options based on social information associated with one or more additional users having highest affinities; and
providing the selected recommended options to the user.

8. The computer-implemented method of claim 1, wherein providing the one or more recommended options to the user comprises:
determining affinities between a retailer providing the customizable product and each of the additional users connected to the user;
selecting recommended options based on social information associated with one or more additional users having at least a threshold affinity; and
providing the selected recommended options to the user.

9. The computer-implemented method of claim 1, wherein providing the one or more recommended options to the user comprises:
determining, for each of the additional users connected to the user, a number of transactions between an additional user and a retailer providing the customizable product;
selecting recommended options based on social information associated with one or more additional users having number at least a threshold number of transactions; and
providing the selected recommended options to the user.

10. The computer-implemented method of claim 1, wherein providing the one or more recommended options to the user comprises:
determining, for each of the additional users connected to the user, a time associated with an action with a retailer providing the customizable product;
selecting recommended options based on social information associated with one or more additional users having a time associated with an action with the retailer within a threshold time of a current time; and
providing the selected recommended options to the user.

11. The computer-implemented method of claim 1, wherein determining one or more recommended options for the customizable product based on the retrieved social information associated with the one or more additional users of the social networking system connected to the user comprises:
determining whether social information associated with an additional user is associated with one or more options for the customizable product based on stored information mapping social information to options; and
selecting one or more options associated with the additional user if the social information associated with the additional user is mapped to one or more options.

12. The computer-implemented method of claim 1, wherein the retrieved social information is selected from a group consisting of: content posted by an additional user to the social networking system, actions performed by the additional user, demographic information associated with the additional user, and any combination thereof.

13. A computer-implemented method comprising:
receiving a request for a customizable product from a user, the customizable product having a plurality of selectable options;
identifying the customizable product and the user to a social networking system;
receiving one or more recommended options for the customizable product from the social networking system, the recommended options based at least in part on social information associated with additional users of the social networking system connected to the user;
receiving a selection of one or more of the recommended options for the customizable product; and
transmitting a notification of the selected one or more recommended options and the user to the social networking system.

14. The computer-implemented method of claim 13, further comprising:
receiving an identification of an additional user associated with the selected one or more recommended options; and
providing a credit to an account associated with the additional user associated with the selected one or more recommended options.

15. The computer-implemented method of claim 14, wherein providing the credit to the account associated with the additional user associated with the selected one or more recommended options comprises:
increasing an amount of a rewards program associated with the additional user.
